(19) United States
(12) Patent Application Publication
(10) Pub. No.: US 2026/0037106 A1
(43) Pub. Date: Feb. 5, 2026

(54) Common Interaction Architecture

(71) Applicant: ServiceNow, Inc., Santa Clara, CA (US)

(72) Inventors: Rohan Rasane, Santa Clara, CA (US); Corey Leamon, Santa Clara, CA (US); Ben Holland-Arlen, Santa Clara, CA (US); Pooja Patil, Santa Clara, CA (US); Justin denBroeder, Santa Clara, CA (US); Niyati Parikh, Santa Clara, CA (US); Rafael Lagares Vale, Santa Clara, CA (US)

(21) Appl. No.: 18/825,460

(22) Filed: Sep. 5, 2024

Related U.S. Application Data
(60) Provisional application No. 63/677,624, filed on Jul. 31, 2024.

(51) Int. Cl. G06F 3/0484; G06F 3/0481; G06F 11/34

(52) U.S. Cl. CPC G06F 3/0484; G06F 3/0481; G06F 11/3438

(57) ABSTRACT

An embodiment may involve obtaining a first content interaction indicator that indicates a first user interaction with content of a first application, and obtaining a second content interaction indicator that indicates a second user interaction with content of a second application different from the first application, obtaining a set of content interaction rules associated with the first and second applications, and, in response to determining, based on the first and second content interaction rules, that each of the first and second user interactions satisfies the set of content interaction rules, generating display instructions for displaying the first and second user interactions.

### CROSS-REFERENCE TO RELATED APPLICATIONS

This application claims priority to U.S. Provisional Patent Application No. 63/677,624 filed on Jul. 31, 2024, the entire content of which is hereby incorporated herein by reference.

### BACKGROUND

Certain software platforms include functionality to enable user interaction with content on the platform, such as user reactions, user comments, or other types of user feedback. However, managing and organizing the user interactions, especially in large-scale cloud platforms and associated applications, is challenging for several reasons. For example, different platforms and/or applications may have different interaction mechanisms, resulting in an inefficient management of the interaction mechanisms. The inefficient mechanism results in a relatively high utilization of computational, memory, or communication resources within and across the platforms.

### SUMMARY

Various implementations disclosed herein relate to a cross-application, common interaction architecture for software platforms, which may prevent unnecessary complexity or duplications among multiple software platforms and/or applications that make use of interaction operations. In particular, the embodiments herein describe a common data model, common interaction rules, application programming interface (API), and user experience for obtaining, storing, displaying, and manipulating content interactions among the multiple software platforms and/or applications.

Accordingly, a first example embodiment may involve may involve obtaining a first content interaction indicator that indicates a first user interaction with content of a first application, and obtaining a second content interaction indicator that indicates a second user interaction with content of a second application different from the first application. The first example embodiment may also involve obtaining a set of content interaction rules associated with the first and second applications. The first example embodiment may also involve, in response to determining, based on the first and second content interaction indicators, that each of the first and second user interactions satisfies the set of content interaction rules, generating display instructions for displaying the first and second user interactions.

A second example embodiment may involve a computing system. The computing system may include at least one processor, as well as memory and program instructions. The program instructions may be stored in the memory, and upon execution by the at least one processor, cause the computing system to perform operations in accordance with the first example embodiment.

A third example embodiment may involve a non-transitory computer-readable medium, having stored thereon program instructions that, upon execution by a computing system, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts an overview of content publishing and content interactions, in accordance with example embodiments.

FIG. 7A depicts components of a data model, in accordance with example embodiments.

FIG. 7B depicts components of a data model, in accordance with example embodiments.

FIG. 8A depicts an API request associated with a comment, in accordance with example embodiments.

FIG. 8B depicts an API response associated with a comment, in accordance with example embodiments.

FIG. 8C depicts an API request associated with a reaction, in accordance with example embodiments.

FIG. 8D depicts an API response associated with a reaction, in accordance with example embodiments.

FIG. 8E depicts an API request associated with a document, in accordance with example embodiments.

FIG. 8F depicts an API response associated with a document, in accordance with example embodiments.

FIG. 9A depicts a workflow for reactions, in accordance with example embodiments.

FIG. 9B depicts a workflow for reactions, in accordance with example embodiments.

FIG. 9C depicts a workflow for comments, in accordance with example embodiments.

FIG. 9D depicts a workflow for comments, in accordance with example embodiments.

FIG. 10A depicts a user interface, in accordance with example embodiments.

FIG. 10B depicts a user interface, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. EXAMPLE TECHNICAL IMPROVEMENTS

Current approaches involve individual platforms and/or applications each having their own interaction and feedback mechanisms. However, these techniques are resource-intensive and often do not provide for interoperability between different applications. In particular, application-specific interaction mechanisms lead to unnecessary duplication of code, thus wasting memory resources. Additionally, application-unique interaction mechanisms can lead to user confusion due to inconsistent look and feel between different applications, thus causing users to spend more time navigating and refreshing pages and windows of the user interface and thereby using more computing resources.

The embodiments herein overcome these limitations by providing a common interaction architecture that can obtain, store, display, and manipulate content interactions among multiple software platforms and/or applications.

This approach eliminates the costly duplication of interaction and other feedback mechanisms that arises when each platform and/or application has its own approach. A common architecture makes it so that interaction mechanisms do not need to be designed separately for each application, saving developer time and reducing duplication of code and therefore memory usage. Additionally, a common look and feel among interaction mechanisms across different software platforms and/or application will reduce the amount of time end-users spend navigating the user interface, thus saving computing resources.

Other technical improvements may also flow from these embodiments, and other technical problems may be solved. Thus, this statement of technical improvements is not limiting and instead constitutes examples of advantages that can be realized from the embodiments.

### II. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. EXAMPLE COMPUTING DEVICES AND CLOUD-BASED COMPUTING ENVIRONMENTS

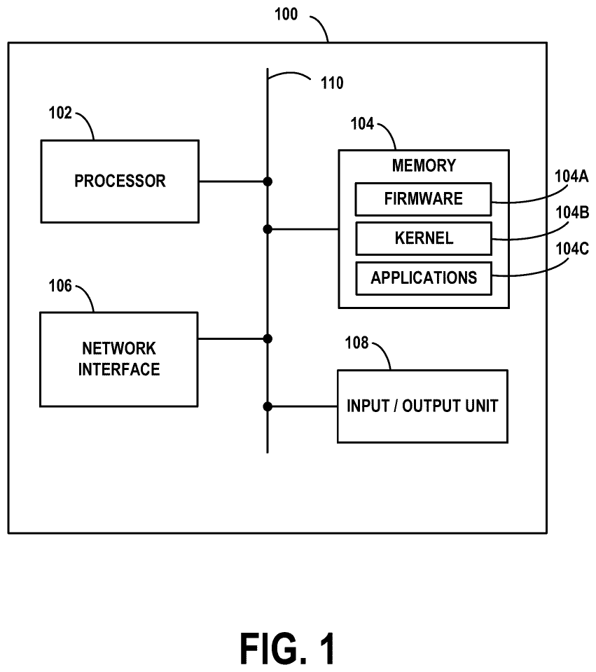

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

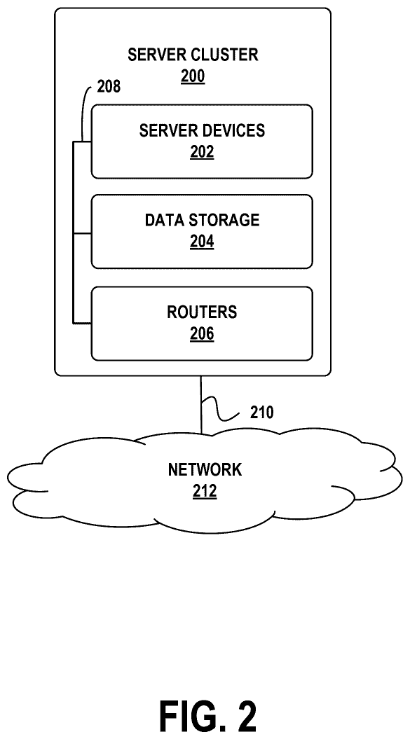

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PUP Hypertext Preprocessor (PUP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. EXAMPLE REMOTE NETWORK MANAGEMENT ARCHITECTURE

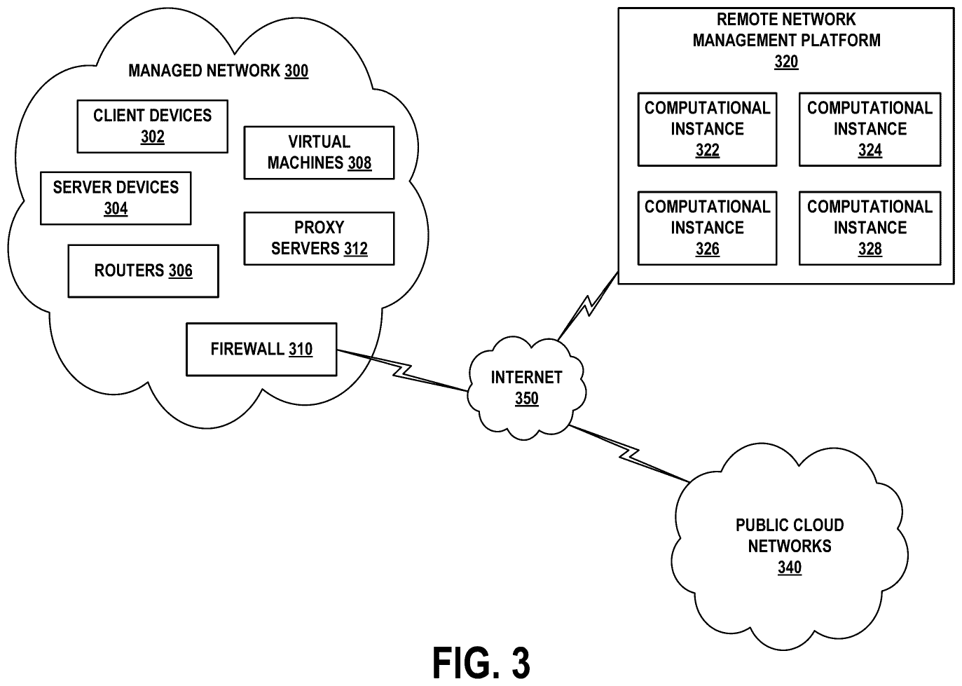

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

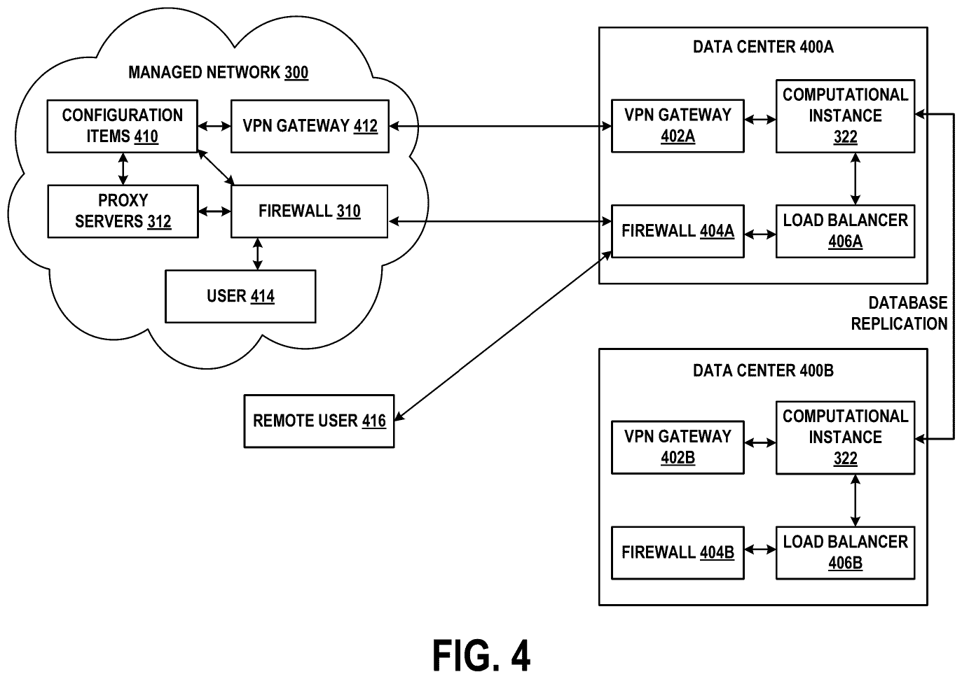

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. EXAMPLE DISCOVERY

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

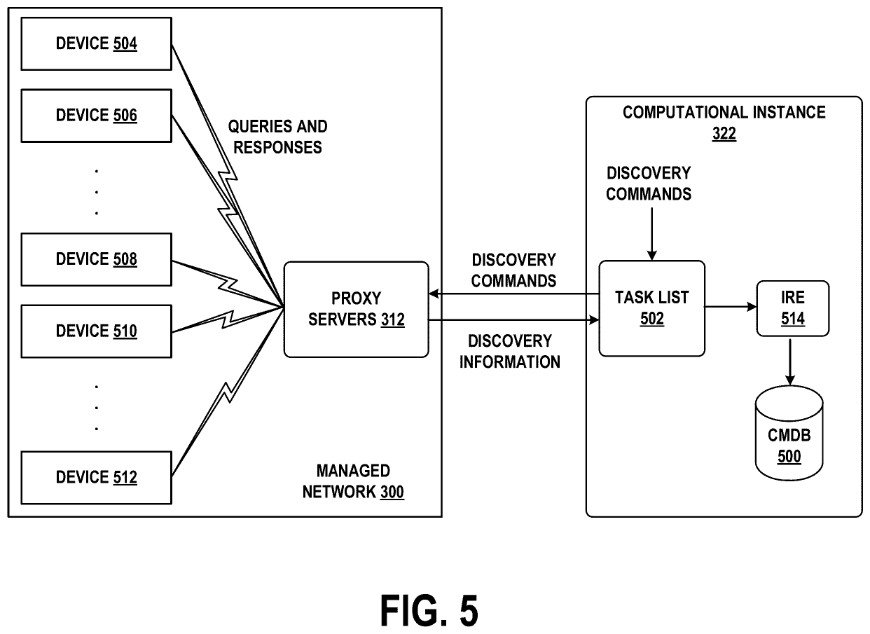

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular device during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB IDENTIFICATION RULES AND RECONCILIATION

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of RE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. COMMON INTERACTION ARCHITECTURE

### A. Overview of Content Publishing and Content Interactions

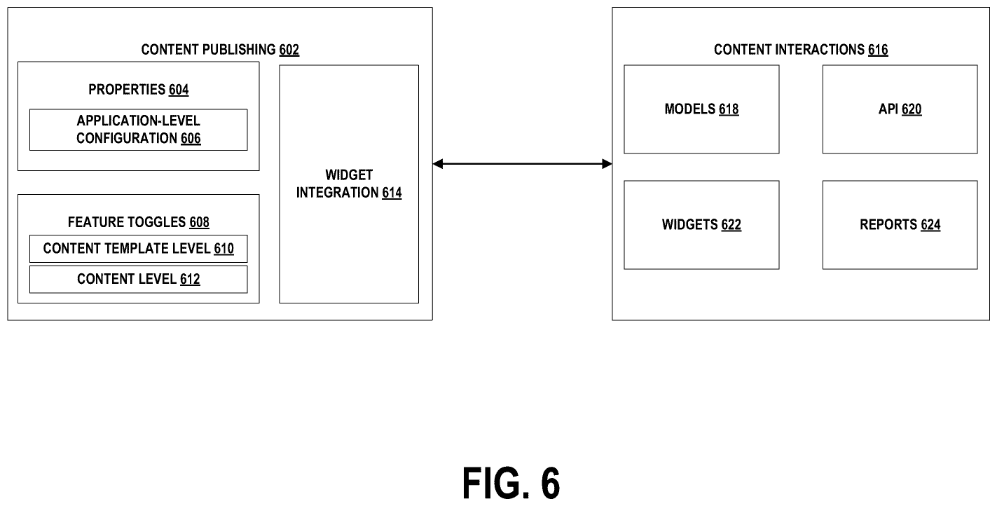

When interacting with content, whether through a platform or application as described above or another method, a general schema may be followed as illustrated in the overview 600 of FIG. 6. In particular, such a schema may involve two main components: content publishing 602 and content interactions 616. While generally content publishing 602 may occur temporally prior to content interactions 616, in some embodiments the opposite may be true. In this disclosure, the term “content interaction” and “user interaction” are generally synonymous unless context suggests otherwise.

Content publishing 602 may involve making content items generally available to the users of a platform and/or application. Content publishing 602 may include properties 604 associated with applications and content items. In a case where multiple platforms and/or applications are involved, each platform and/or application may have its own specific application-level configuration 606. This allows for more granular control over content items associated with each platform and/or application.

Content publishing 602 may also involve feature toggles 608 which may influence the properties of the content items. For example, such properties may be determined at a content template level 610, where templates are provided for more efficient changes to content items, and/or at the content level 612, representative of the content item itself.

Content publishing 602 may also involve widget integration 614, as related processes may be manipulated through a UI interface making use of widgets and other related UI elements as will be discussed later.

Content interactions 616 are associated with content items. Examples include comments (e.g. text-based content interactions), views (e.g. a viewing action by a user and may involve a number of times a content item has been provided by an application and/or platform), and reactions (e.g. image-based user interactions such as emojis). Content interactions 616 in the embodiment herein may involve models 618, including a data model for representation within an application and/or platform. The data model 700 discussed below is one example of a model that may be included within the models 618.

Content interactions 616 may also involve an application programming interface (API) 620 that allows for retrieval, submission, and editing of the content items and/or content interactions represented in the models 618.

Content interactions 616 may also involve widgets 622, which may include UI interface elements that allow a user to view content items and submit and/or view content interactions.

Content interactions 616 may also involve reports 624. Models 618 may include statistics (such as view counts and the number of content interactions) that may be aggregated into reports that may be used for analysis and evaluation of content items. For instance, a report may be generated for specific types of content items to determine their relative popularity.

### B. Data Model

In order to simplify the relationship between content publishing and content interactions and to better streamline such interactions, the embodiments herein implement a common interaction architecture.

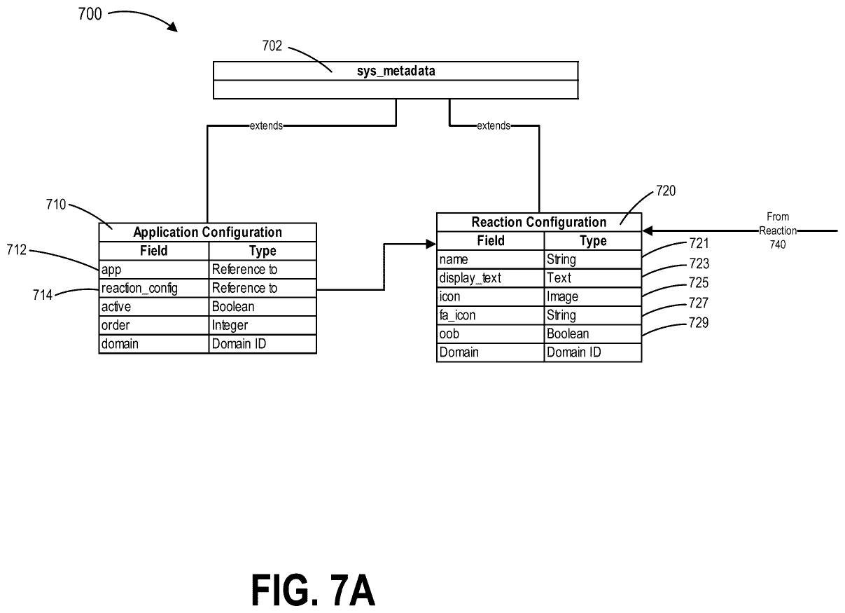

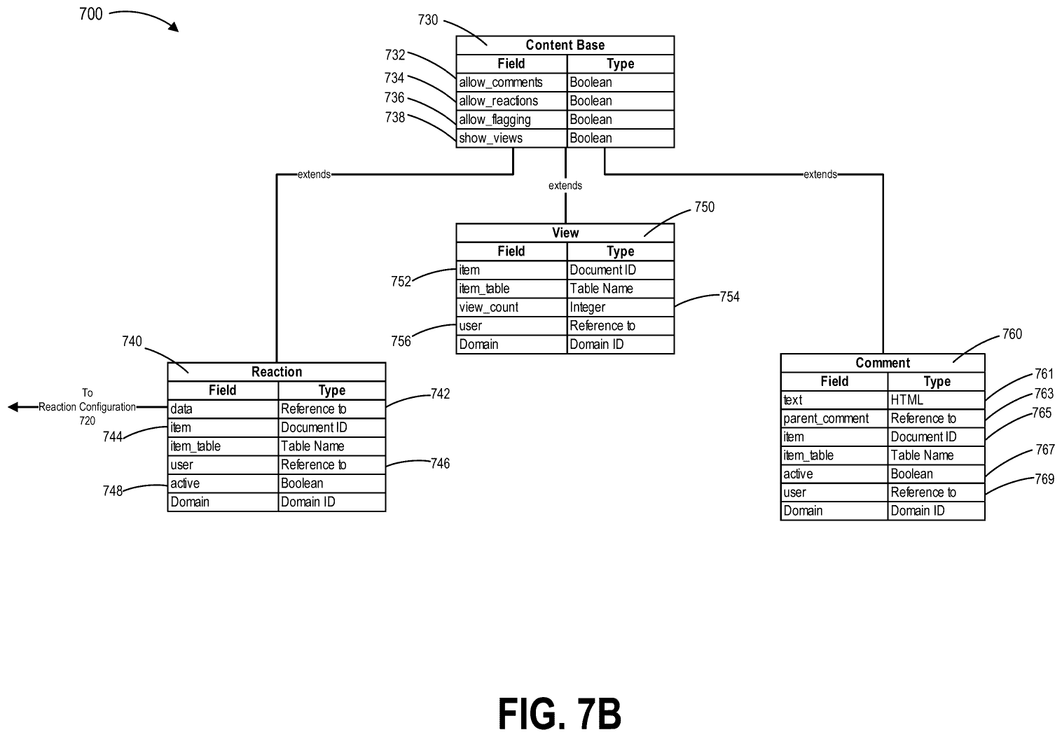

FIGS. 7A and 7B depict components of a data model 700 that represent specific information that may be included in or used by the common interaction architecture in some embodiments. FIGS. 7A and 7B represent this information by way of providing a possible schema for information related to content interactions and the common interaction architecture. However, this is only a possible schema; in some embodiments, the data model 700 may contain information according to the illustrated schema and/or information according to other schemas not illustrated.

As noted above, an example of content interactions may be a reaction (e.g. an emoji, reply, or other short response) posted in reply to published content. In the data model 700, such a content interaction may be represented among metadata 702 stored in association with the platform or application, as illustrated in FIG. 7A.

The common interaction architecture allows for application-specific customization of application configuration 710 may extend metadata 702 to include further information related to content interactions and the application. For example, application configuration 710 may include an application reference 712, which may link the application configuration 710 (and thus the common interaction architecture) to a specific application running on the platform as described above. Additionally, the application configuration 710 may include a reaction configuration reference 714, which may link the application configuration 710 to one or more versions of a reaction configuration 720 as described below. As illustrated in FIG. 7A, application configuration 710 may also include other fields, such as an active Boolean, representing whether the application is enabled or disabled, an order integer, and a domain ID.

Reaction configuration 720 represents the data for a reaction or other interaction, including possible options presented to a user and how the reaction is represented in the data model 700. Multiple versions of a reaction configuration 720 may exist within the data model 700, for example each representing a different reaction or other interaction.

Reaction configuration 720 may include a name 721, describing the reaction as a string. Examples include “like,” “love,” “care,” “haha,” “clap,” “thumbs-up,” and “thumbs-down,” among others. A reaction configuration 720 may include display_text 723, which may contain the translated text or other text-based representation of the reaction for display to the user (for instance, in the situation where a system reads out what is on the screen for a sight-impaired user). Examples of display_text include “Like,” “Love,” “Care,” “Ha-Ha,” and “Clap,” among others. As such, the display_text 723 may or may not correspond to the name 721 of the reaction configuration 720.

Reaction configuration 720 may include an icon 725, which may be an image related to the reaction. For example, it may be an emoji, meme, or other image, and may be in a variety of image-based formats, including Scalable Vector Graphics (SVG), Joint Photographic Experts Group (JPG), Portable Network Graphics (PNG), and/or Graphics Interchange Format (GIF). A reaction configuration 720 may also include fa_icon 727, which describes the icon 725 in text format and may be stored as a string. An example of fa_icon 727 may be a filename or file path for a specific image that may be retrieved for that type of reaction. For example, for a heart emoji (associated with a “love” name 721 and “Love” display_text 723) may have an fa_icon 727 of fa-heart-o.

Reaction configuration 720 may include an oob 729 boolean, which may represent whether the reaction is “out-of-box”. The use case of such a flag may be in a situation where an application that the reaction configuration 720 is linked to is missing. In such a case, if the oob 729 boolean is true, this would indicate that the reaction is included in a default collection of reactions shipped with the common interaction architecture and thus may be retrieved that way, rather than attempting to find it among an application configuration 710 or its linked items (e.g. by way of application reference 712). As illustrated in FIG. 7A, application configuration 710 may also include other fields in some embodiments, such as a domain ID.

FIG. 7B depicts further components and schemas of components of the data model 700.

As depicted in FIG. 7B, the data model 700 may include a content base 730, from which other types of content (including reactions, views, comments, reporting flags, and other types of interactions) may be extended and thus also represented within the data model 700. As depicted, content base 730 may include a series of Booleans that may determine which types of interactions may be allowed, including allow_comments 732 (whether interactions of the comment type are permitted), allow_reactions 734 (whether interactions of the reaction type are permitted), and allow_flagging 736 (whether interactions of the reporting flag are permitted). Content base 730 may also include a Boolean determining whether the amount of views on a content item are shown to users, as with show views 738.

Reaction record 740 extends the content base 730 to include further information related to a specific reaction within the data model 700. Reaction record 740 may include data 742, which links the reaction record 740 to a reaction configuration 720 (as illustrated in FIG. 7A). This links the reaction record 740 to the content of the reaction itself (such as the name, image, etc. associated with the reaction) that is stored in association with a reaction configuration 720.

Reaction record 740 may also include an item 744, which may be a document ID that refers and/or links the reaction record 740 to another content item. This content item may be another content interaction as described herein or a different content item, such as a document or image. Reaction record 740 may include a user 746, that refers and/or links the reaction record 740 to a specific user represented in the data model 700. This has the use case of identifying the user who made the reaction. Additionally, reaction record 740 may include an active 748 boolean, which represents whether the reaction is enabled or disabled. This allows for “soft-delete” functionality, in which existing reactions are not deleted, but new reactions of the same type are not permitted. As illustrated in FIG. 7B, reaction record 740 may also include other fields in some embodiments, including an item_table if the item 744 is stored in a table, and/or a domain ID.

View record 750 extends the content base 730 to include further information related to another type of content interaction within the data model 700, in this case the viewing of a content item. View record 750 may include an item 752, which may be a document ID that refers and/or links the view record 750 to another content item. This content item may be another content interaction as described herein or a different content item, such as a document or image. View record 750 may include a view_count 754 that may be, in some embodiments, incremented when a user views a content item. View record 750 may include a user 756, that refers and/or links the view record 750 to a specific user represented in the data model 700. This has the use case of identifying the user who performed the view action (i.e. viewed the content item).

As illustrated in FIG. 7B, view record 750 may also include other fields in some embodiments, including an item_table if the item 750 is stored in a table, and/or a domain ID.

Comment record 760 extends the content base 730 to include further information related to another type of content interaction within the data model 700, in this case a comment (e.g. a primarily text interaction attached to another content item). Comment record 760 may include text 761, which is illustrated in FIG. 7B as being in HTML format, but may be in another text-related format, such as XML, plain text, or others. Comment record 760 may include parent_comment 763, which is a reference to another comment record 760 or other content interaction within the data model 700. This allows for “threading” functionality, where users may reply to the interactions of other users. Within the data model, comment records may be linked together in a chain of comments.

Comment record 760 may include an item 765, which may be a document ID that refers and/or links the comment record 760 to another content item. This content item may be another content interaction as described herein or a different content item, such as a document or image. Additionally, comment record 760 may include an active 767 boolean, which represents whether the reaction is enabled or disabled. This allows for “soft-delete” functionality, in which existing reactions are not deleted, but new reactions of the same type are not permitted. Comment record 760 may include a user 769, that refers and/or links the comment record 760 to a specific user represented in the data model 700. This has the use case of identifying the user who made the comment.

As illustrated in FIG. 7B, comment record 760 may also include other fields in some embodiments, including an item_table if the item 765 is stored in a table and/or a domain ID.

Also included within the data model 700, but not necessarily linked to content interactions directly, may be a list of filtered keywords. Each keyword may be represented with a schema including the keyword itself as a string, as well as an active Boolean that determines whether the keyword should be filtered or not. If the Boolean is True, for example, the system may not permit content interactions that contain the filtered keyword. This allows for more efficient and simple moderation of content interactions without needing to check content interactions after they are posted or sent.

### C. API

The data model described with reference to FIGS. 7A and 7B represent how information relating to content interactions may be stored and organized within a system. Next, interactions with this data itself will be described through examples of an API. The API and the data model 700 may interact according to content interaction rules.

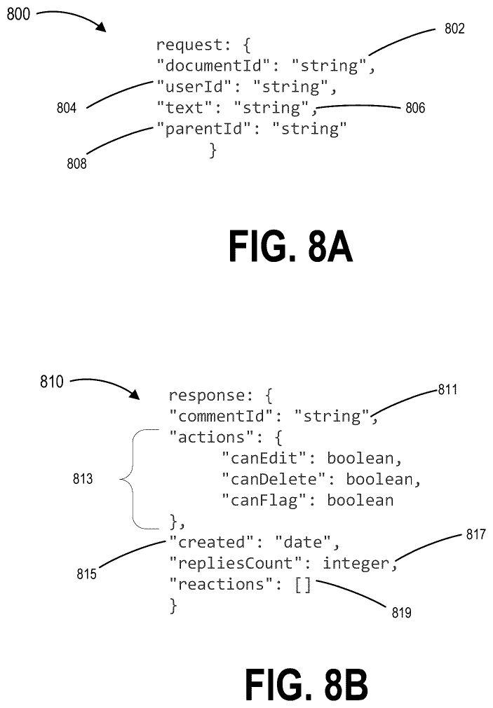

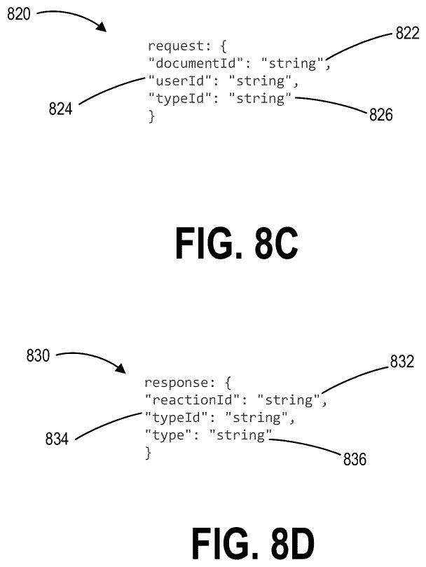

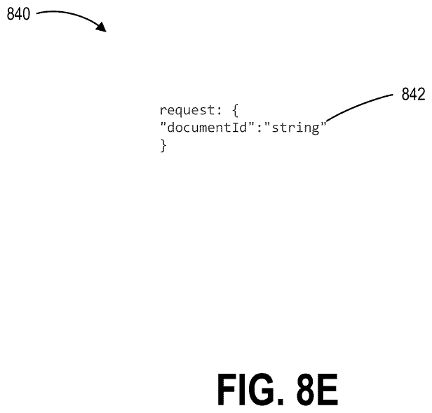

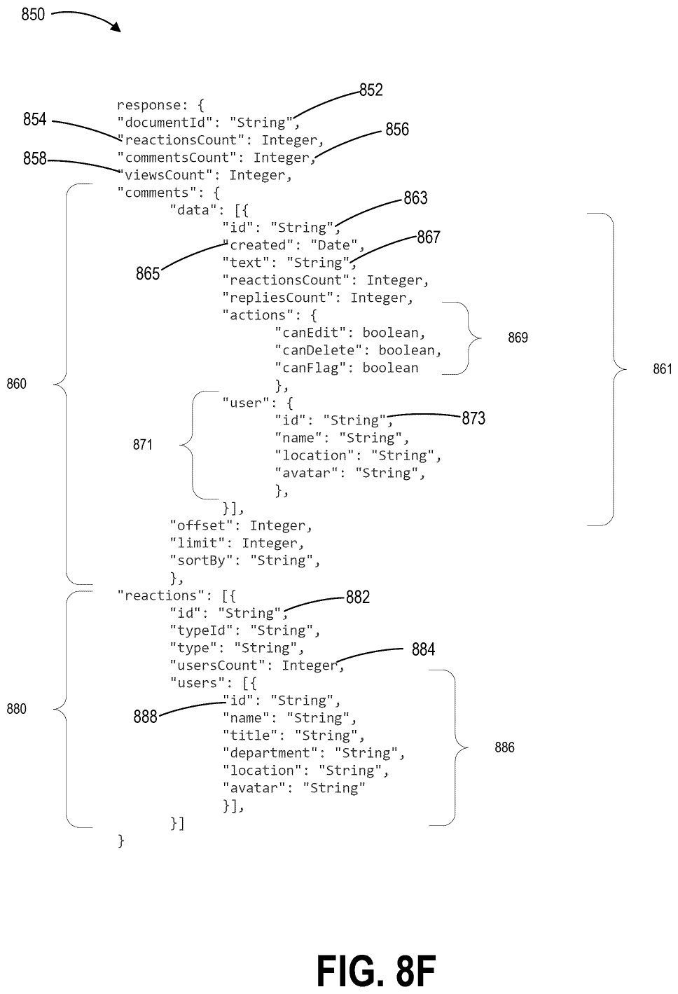

FIGS. 8A and 8B depict a comment request 800 and a comment response 810, respectively, for comments related to the embodiments herein. Such comments may be represented in the data model 700 as a comment record 760 and associated items. In the examples of FIGS. 8A and 8B, the API requests and API responses are depicted in JSON format, though other formats may be used in some embodiments. In the following disclosure, when it is said that a field in an API request or response “corresponds” to a field within the data model 700, it is intended to mean that the request may create or edit such a field in the data model 700, and a response may retrieve information from that field in the data model 700.

As depicted in FIG. 8A, comment request 800 may include a documentID field 802, which may indicate which content item the comment is intended to be in response to. Such a documentID field 802 may correspond to the item 765 of a comment record 760 within the data model 700, as discussed in relation to FIG. 7B above. Comment request 800 may include a userID field 804, which may identify the user that is submitting the comment. This field may correspond to the user 769 field of a comment record 760 within the data model 700.

Comment request 800 may include a text field 806, which may include the text of the comment that is being submitted. While depicted in FIG. 8A as a string, this field may be a different type of text-related format, including HTML, XML, plain text, or others. In such cases, an HTML or XML formatted text field 806 may be encoded to be included within a JSON-format comment request 800. This text field 806 may correspond to text 761 included in a comment record 760 within the data model 700. Comment request 800 may include a parentID field 808, which may be used in a case where comments are “threaded,” with comments structured in reply to one another. In such a case, the parentID field 808 may correspond to a parent_comment 763 reference included in a comment record 760 within the data model 700.

FIG. 8B depicts a comment response 810. A comment response 810 may be provided by a platform and/or application in response to receiving a comment request 800. Comment response 810 may include a commentID 811, which may be a documentID as described above or another identifier for a comment within the data model 700 as represented by a comment record 760.

Comment response 810 may include actions 813, which may contain a variety of Boolean flags representing permissions associated with the comment record 760 that is being retrieved along with the comment response 810. Such flags could include whether the comment may be edited, whether it may be deleted, or whether it may be flagged for moderation, as illustrated in FIG. 8B. The actions 813 may correspond to the flags 732, 734, and 736 included in content base 730, described above in relation to FIG. 7B and which comment record 760 extends.

Comment response 810 may include a created timestamp 815, which may record the date and time the comment was submitted. Comment response 810 may also include a list of reactions 819, which may correspond to the reactions associated with the comment record 760 being retrieved by the comment response. In this way, the reactions list 819 may correspond to versions of reaction configuration 720 and reaction record 740 (described above in relation to FIGS. 7A and 7B) linked to the comment through references. The length of this reactions list 819 thus may comprise a number of replies or reactions to the comment, and may be included separately within the comment response 810 as a repliesCount 817.

FIGS. 8C and 8D depict a reaction request 820 and reaction response 830, respectively, for reactions related to the embodiments herein. Such reactions may be represented in the data model 700 as a reaction configuration 720, reaction record 740, and associated and/or linked items. In the examples of FIGS. 8C and 8D, the API requests and API responses are depicted in JSON format, though other formats may be used in some embodiments.

Reaction request 820 may be used to post or otherwise submit a reaction. Reaction request 820 may include a documentID 822 which may be a documentID as described above or another identifier for a comment within the data model 700 as represented by a reaction configuration 720, reaction record 740, and associated and/or linked items. Reaction request 820 may include a userID field 824, which may identify the user that is submitting the reaction. This field may correspond to the user 746 field of a reaction record 740 within the data model 700. Reaction request 820 may also include a typeID 826, which may identify the type of reaction. Such an ID may correspond to a name 721 or icon 725 fields of a reaction configuration 720 within the data model 700.

FIG. 8D depicts a reaction response 830. A reaction response 830 may be provided by a platform and/or application in response to receiving a reaction request 820. Reaction response 830 may include a reactionID 832, which may be an identifier for the reaction within the data model 700. Reaction response 830 may also include a typeID 834 and/or a type 836, which may identify the type of reaction. Such an ID may correspond to a name 721 or icon 725 fields of a reaction configuration 720 within the data model 700.

FIG. 8E depicts a document request 840. Such a request may be used to retrieve a content item and its associated content interactions. In some embodiments, a document request 840 may include a documentID 842, which may indicate which content item (and associated content interactions) the document request 840 is intended to retrieve. Such a documentID field 802 may correspond to the item 744 of a reaction record 740, an item 752 of a view record 750, or an item 765 of a comment record 760, all within the data model 700 as discussed in relation to FIGS. 7A and 7B above.

FIG. 8F depicts a document response 850. A document response 850 may be provided by a platform and/or application in response to receiving a document request 840. Document response 850 may include a documentD 852, which may indicate which content item (and associated content interactions) the document response 850 concerns. DocumentID 852 in such a situation thus may be the same as documentID 842 in FIG. 8E.

Document response 850 may include a reactionsCount 854, which indicates the number of reactions associated with the content item. Document response 850 may include a commentsCount 856, which indicates the number of comments associated with the content item. Document response 850 may also include viewsCount 858, which indicates the number of times the content item has been viewed. Each of these counts may be used in some embodiments to evaluate content interactions trends and which types of content receive more interactions. Such information may be included in reports 624 as discussed above in relation to FIG. 6.

Document response 850 may include a comments list 860. For each comment in the list of comments, a variety of information may be included in the document response 850.

Each comment in the comments list 860 may include data fields 861, containing information about each comment. Such information may correspond to matching and/or similar fields within an associated comment record 760 within the data model 700, as described above.

For instance, data fields 861 may include an ID 863, which may involve a unique identifier assigned to a comment and its associated comment record 760 within the data model 700. Data fields 861 may include a created timestamp 865, which may record the date and time the comment was submitted. Data fields 861 may also include a text field 867, which may include a text portion of the comment in question. This field may correspond to text 761 within an associated comment record 760 within the data model 700. In some embodiments, data fields 861 may include a count of the reactions associated with a comment and/or a count of the comments made in reply to a comment.

Data fields 861 may also include actions 869, which may contain a variety of Boolean flags representing permissions associated with the comment record 760 that is being retrieved along with the document response 850. Such flags could include whether the comment may be edited, whether it may be deleted, or whether it may be flagged for moderation, as illustrated in FIG. 8F. Actions 869 may correspond to the flags 732, 734, and/or 736 included in content base 730, described above in relation to FIG. 7B and which comment record 760 extends.

Data fields 861 may also include user fields 871, which may contain information relating to a specific user that made a comment. For instance, user fields 871 may include a user ID 873, which may identify the user that submitted the associated comment in the comments list 860. Such a user ID 873 may correspond to the user 769 field of a comment record 760 within the data model 700, as illustrated in FIG. 7B. User fields 871 may also include information about the user, including name, location, and/or avatar.

In some embodiments, the comments list 860 may include an offset value, a limit value, and a sort-by instruction.

Document response 850 may also include a reactions list 880. For each reaction in the reactions list 880, a variety of information may be included in the document response 850.

Each reaction in the reactions list 880 may include an ID 882, which may involve a unique identifier assigned to a reaction and its associated reaction record 740 within the data model 700. Each reaction in the reactions list 880 may include in some embodiments a typeID and type value. A count of users who have made a reaction may be included in each reaction in the reactions list as usersCount 884.

Each reaction in the reactions list 880 may also include user fields 886, which may contain information relating to a specific user that made a reaction. For instance, user fields 886 may include a user ID 888, which may identify the user that submitted the associated reaction in the reactions list 880. Such a user ID 888 may correspond to the user 746 field of a reaction record 740 within the data model 700, as illustrated in FIG. 7B. User fields 886 may also include information about the user, including name, location, and/or avatar.

### D. Example Workflows

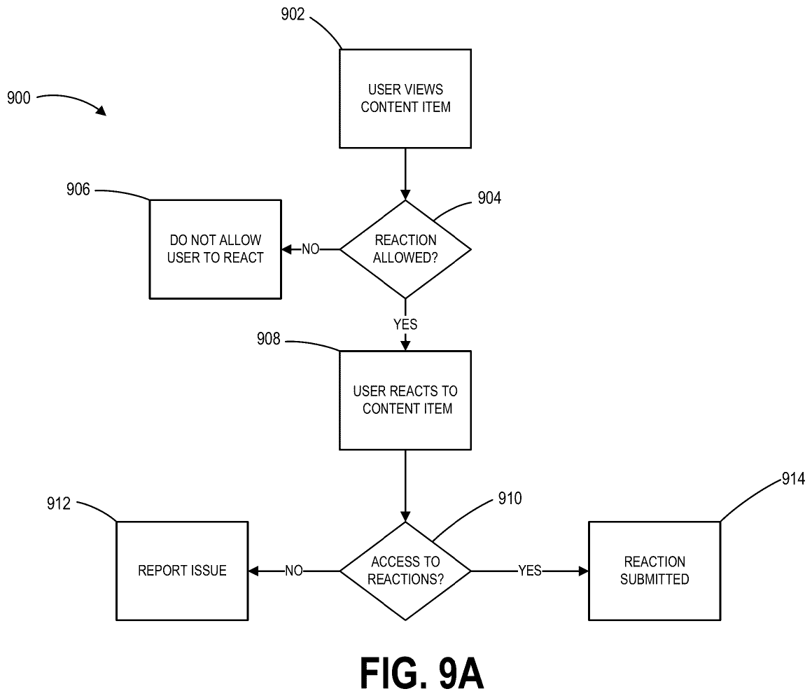

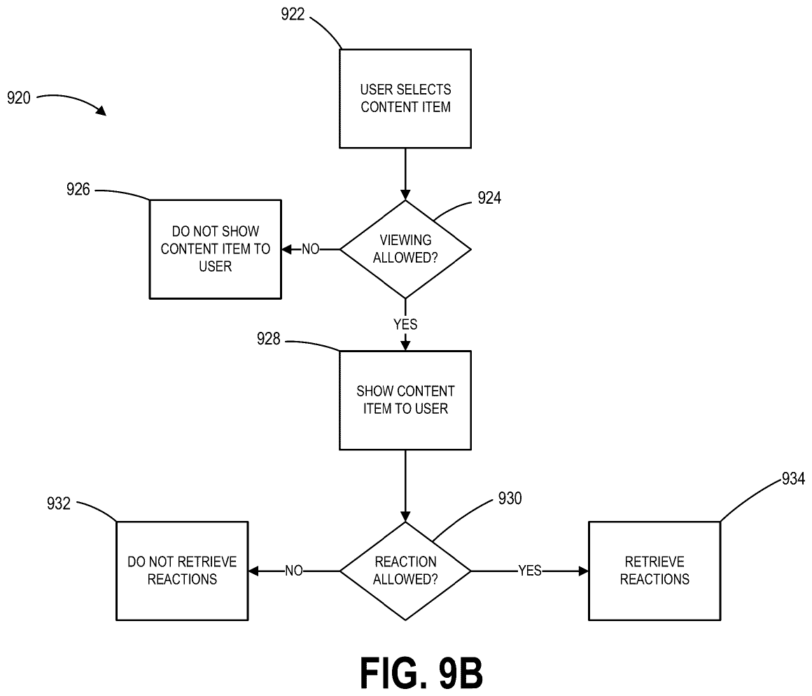

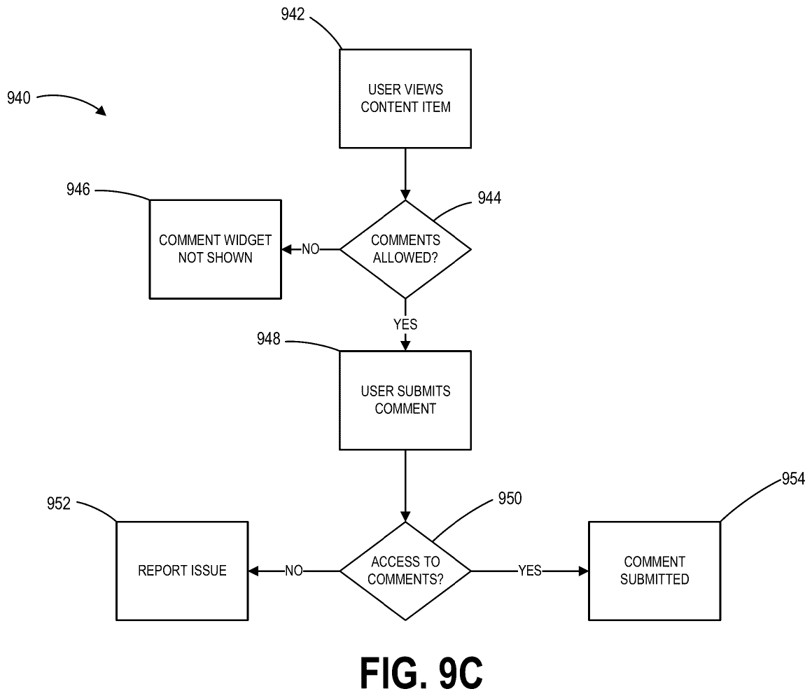

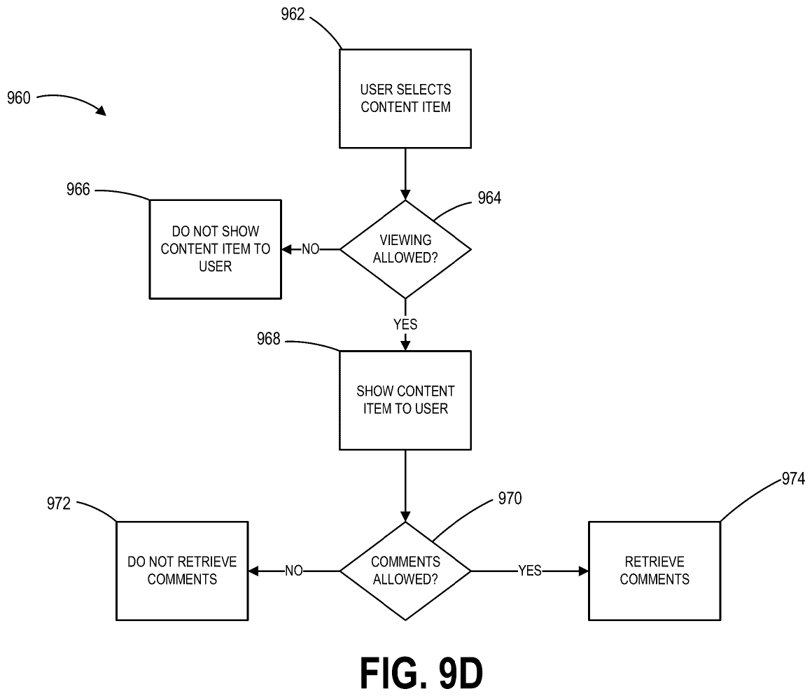

In order to make use of the above-described APIs for content interactions, users may follow one or more of the following logic flows as described with reference to FIGS. 9A-9D.

FIG. 9A depicts a workflow 900 for submitting a reaction. The workflow (and other workflows discussed herein) may be performed by a user, who may be a regular user (without elevated privileges) or an administrator (with elevated privileges).

Block 902 may involve a user viewing a content item. Such a viewing action may be recorded in the data model 700 as a view record 750.

Block 904 may involve determining whether reactions are permitted for the content item viewed by the user. This action may involve checking an allow_reactions 734 flag within the content base 730 associated with the content item viewed by the user. If reactions are not permitted, the workflow may proceed to block 906. Otherwise, the workflow may proceed to block 908.

Block 906 may involve not permitting the user to submit a reaction to the content item. The workflow may end at this point.

Block 908 may involve the user submitting a reaction (emoji, etc.) to the content item they are viewing.

Block 910 may involve determining if the user has access to view reactions. Such permissions may be user-specific and/or dependent on a privilege level. If the user is not permitted to view reactions, the workflow may proceed to block 912. Otherwise, the workflow may proceed to block 914.

Block 912 may involve reporting an issue. For example, if the user is not permitted to view reactions, an error message may be sent to a user and/or a log indicating such. This may result in an error as the related API request may lack the proper authentication or privileges, and thus an API request may not receive a related API response. An example of an error message could be a pop-up window to the user through a user interface. The workflow may end at this point.

Block 914 may involve the reaction being submitted and the transaction completed. A corresponding reaction record 740 may be created within the data model 700 and linked to the viewed content item. The workflow may end at this point.

Once the workflow has ended, another workflow may begin.

FIG. 9B depicts a workflow 920 for viewing reactions.

Block 922 may involve a user selecting (whether by search, a feed, or other process) a content item to view.

Block 924 may involve determining whether viewing is permitted for the content item viewed by the user. Such permissions may be user-specific and/or dependent on a privilege level. If viewing is permitted, the workflow may proceed to block 926. Otherwise, the workflow may proceed to block 928.

Block 926 may involve not showing the content item to the user, or conversely not permitting the user to view the content item. The workflow may end at this point.

Block 928 may involve showing the content item to the user, or conversely permitting the user to view the content item. This action may involve a document request 840 and/or a document response 850 as depicted in FIGS. 8E and 8F.

Block 930 may involve determining whether reactions are permitted for the content item viewed by the user. This action may involve checking an allow_reactions 734 flag within the content base 730 associated with the content item viewed by the user. If reactions are not permitted, the workflow may proceed to block 932. Otherwise, the workflow may proceed to block 934.

Block 932 may involve not retrieving reactions. The workflow may end at this point.

Block 934 may involve retrieving reactions for the user to view and/or further interact with. This action may involve a reaction request 820 and/or a reaction response 830 as depicted in FIGS. 8C and 8D. The workflow may end at this point.

Once the workflow has ended, another workflow may begin.

FIG. 9C depicts a workflow 940 for submitting comments.

Block 942 may involve a user viewing a content item. Such a viewing action may be recorded in the data model 700 as a view record 750.

Block 944 may involve determining whether comments are permitted for the content item viewed by the user. This action may involve checking an allow_comments 732 flag within the content base 730 associated with the content item viewed by the user. If reactions are not permitted, the workflow may proceed to block 946. Otherwise, the workflow may proceed to block 948.

Block 946 may involve not permitting the user to submit a comment to the content item. This may involve not displaying a commenting widget to the user. The workflow may end at this point.

Block 948 may involve the user submitting a comment to the content item they are viewing.

Block 950 may involve determining if the user has access to view comments. Such permissions may be user-specific and/or dependent on a privilege level. If the user is not permitted to view comments, the workflow may proceed to block 952. Otherwise, the workflow may proceed to block 954.

Block 952 may involve reporting an issue. For example, if the user is not permitted to view reactions, an error message may be send to a user and/or a log indicating such. The workflow may end at this point.

Block 954 may involve the comment being submitted and the transaction completed. A corresponding comment reaction record 760 may be created within the data model 700 and linked to the viewed content item. The workflow may end at this point.

Once the workflow has ended, another workflow may begin.

FIG. 9D depicts a workflow 960 for viewing comments.

Block 962 may involve a user selecting (whether by search, a feed, or other process) a content item to view.

Block 964 may involve determining whether viewing is permitted for the content item viewed by the user. Such permissions may be user-specific and/or dependent on a privilege level. If viewing is permitted, the workflow may proceed to block 966. Otherwise, the workflow may proceed to block 968.

Block 966 may involve not showing the content item to the user, or conversely not permitting the user to view the content item. The workflow may end at this point.

Block 968 may involve showing the content item to the user, or conversely permitting the user to view the content item. This action may involve a document request 840 and/or a document response 850 as depicted in FIGS. 8E and 8F.

Block 970 may involve determining whether comments are permitted for the content item viewed by the user. This action may involve checking an allow_comments 732 flag within the content base 730 associated with the content item viewed by the user. If comments are not permitted, the workflow may proceed to block 972. Otherwise, the workflow may proceed to block 974.

Block 972 may involve not retrieving comments. The workflow may end at this point.

Block 974 may involve retrieving comments for the user to view and/or further interact with. This action may involve a comment request 800 and/or a comment response 810 as depicted in FIGS. 8A and 8B. The workflow may end at this point.

Once the workflow has ended, another workflow may begin.

### E. Example User Interfaces

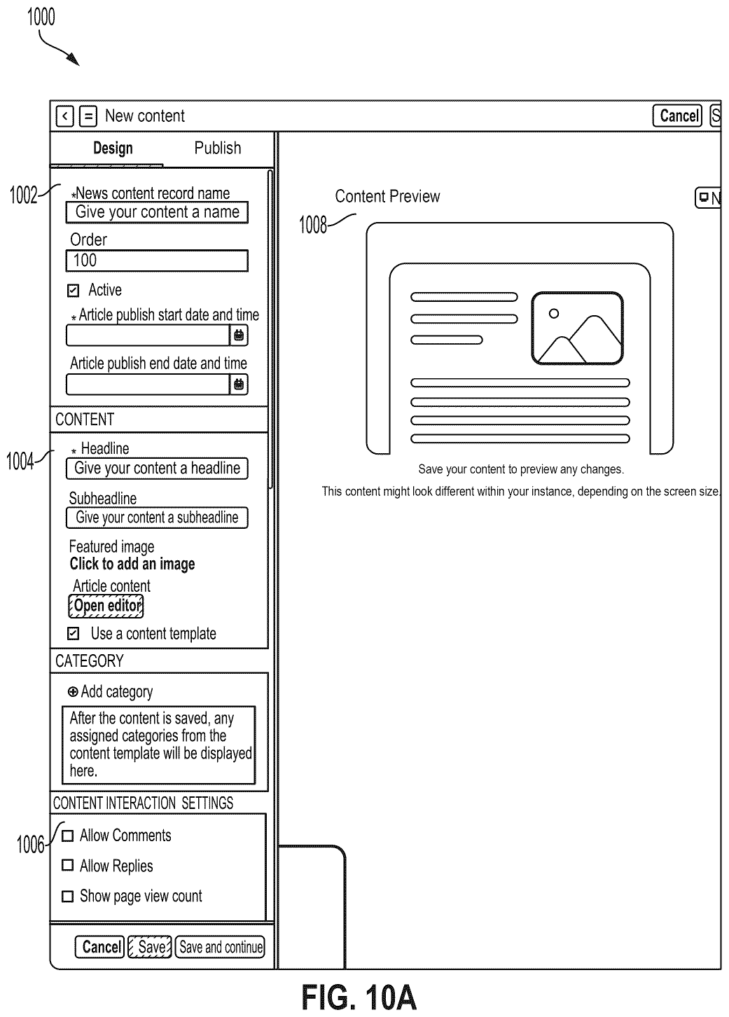

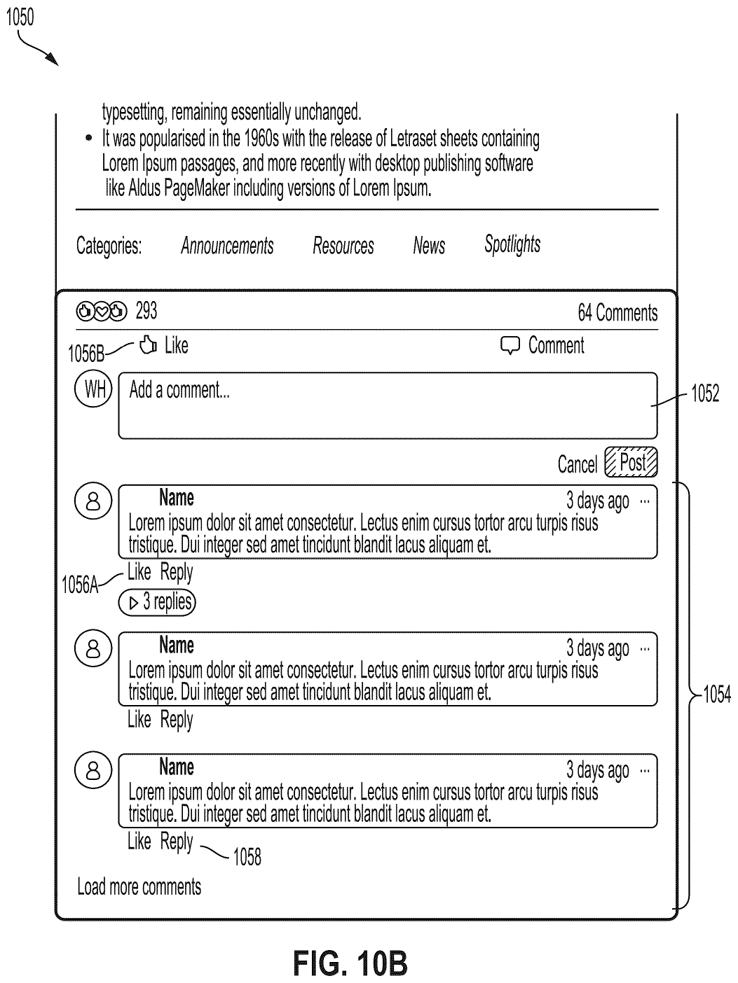

FIG. 10A depicts an example user interface 1000 for content publishing. The user interface may be presented to a user of a platform and/or application. In some embodiments, the user interface may only be presented to a user with sufficient privileges, such as an administrator of the platform and/or application.

User interface 100 may include a content naming window 1002, which allows a user to name or title the content item they intend to publish.

User interface 1000 may include a content editing window 1004, which allows a user to customize the content item they wish to publish, including adding a headline, associated image media, opening an editor window to add text content, and an option to use a content item template.

User interface 1000 may include an interaction settings window 1006, which allows a user to customize the flags associated with the content item, including whether reactions and/or comments are permitted on the content item. This may correspond to may correspond to the flags 732, 734, 736, and/or 738 included in content base 730, described above in relation to FIG. 7B.

User interface 1000 may include a preview window 1008, which allows a user to view the content item they are publishing before it is finalized and published.

When using such a user interface as user interface 1000, the content item may be stored within the data model 700 for operations as described herein.

FIG. 10B depicts a user interface 1050 for content interactions. The user interface may be presented to a user of a platform and/or application.

User interface 1050 may include a comment box 1052, which may allow a user to submit a comment related to a content item. A user's submission of a comment may involve workflows as depicted in FIGS. 9C and 9D, and/or using API functions such as comment request 800 and comment response 810 as depicted in FIGS. 8A and 8B.

User interface 1050 may include a list of comments 1054, which may be retrieved along with a content item through the use of a document request 840 and/or a document response 850 as depicted in FIGS. 8E and 8F. The comments may display information associated with the comments, such as the name of the person who submitted it and a timestamp of when it was submitted. Other information associated with the comments and/or other content interaction may be displayed, including information associated with a user as described above.

User interface 1050 may include a comment reaction button 1056A, illustrated as a “like” button in FIG. 10B but may allow for other reactions in some embodiments. This button may allow a user to submit a reaction to a comment. A user's submission of a reaction may involve workflows as depicted in FIGS. 9A and 9B, an/or using API functions such as reaction request 820 and reaction response 830 depicted in FIGS. 8C and 8D.

User interface 1050 may include a content reaction button 1056B, which functions similarly to the comment reaction button 1056A, but allows for reactions to be linked directly to a content item rather than to a comment.

User interface 1050 may include a reply button 1058, which allows a user to submit a comment in reply to another comment, thus using a “threading” functionality as described above. Corresponding comment records 760 may be linked together using a parent_comment reference 763 as discussed in relation to FIG. 7B. Otherwise, reply comments may be submitted in a similar manner to other comments as described above.

### VIII. EXAMPLE OPERATIONS

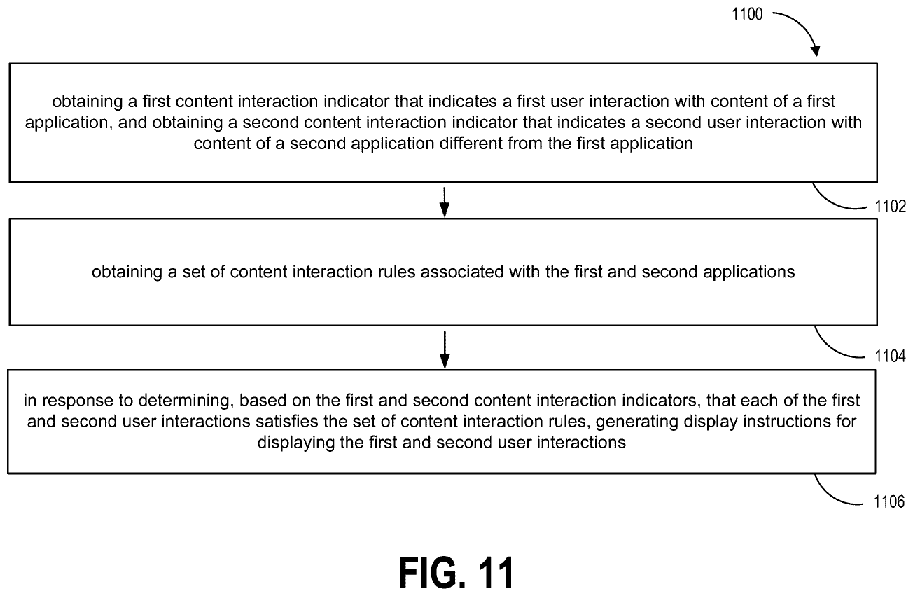

FIG. 11 is a flow chart illustrating an example embodiment. The process 1100 illustrated by FIG. 11 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1102 may involve obtaining a first content interaction indicator that indicates a first user interaction with content of a first application, and obtaining a second content interaction indicator that indicates a second user interaction with content of a second application different from the first application.

This step represents a technical improvement, as process 1100 obtains content interactions indicators from multiple applications, thus eliminating the requirement that each application has its own interaction mechanisms. As discussed previously, the latter approach results in unnecessary duplication of code and waste of memory resources. Additionally, this makes it so that interaction mechanisms do not need to be designed separately for each application, saving developer time and reducing duplication of code and therefore memory usage.

Content relating to the first and second applications may involve content items, as described above.

Block 1104 may involve obtaining a set of content interaction rules associated with the first and second applications.

Block 1106 may involve, in response to determining, based on the first and second content interaction indicators, that each of the first and second user interactions satisfies the set of content interaction rules, generating display instructions for displaying the first and second user interactions.

This step represents a technical improvement as the display instructions for the user interactions may result in a common look and feel among interaction mechanisms across different software platforms and/or applications. This also has the benefit of reducing the amount of time end-users spend navigating the user interface, thus saving computing resources.

To summarize, these steps represent a technical improvement, as they allow for content interactions from multiple applications to be managed by a single process, rather than each application having its own interaction mechanisms. In contrast, the embodiments herein (including process 1100) eliminate these disparate interaction mechanisms and instead implement a common interaction architecture.

In some embodiments, the process 1100 may further involve providing, to the first and second applications, the display instructions for displaying the first and second user interactions.

In some embodiments, the process 1100 may further involve obtaining a third content interaction indicator that indicates a third user interaction with content of a third application different from the first and second applications. In some embodiments, the process 1100 may further involve, in response to determining that the third user interaction satisfies the set of content interaction rules, providing, to the third application, instructions regarding displaying of the third user interaction.

In some embodiments, the process 1100 may further involve obtaining a third content interaction indicator that indicates a third user interaction with content of a third application different from the first and second applications. In some embodiments, the process 1100 may further involve obtaining a further set of content interaction rules specific to the third application. In some embodiments, the process 1100 may further involve, in response to determining that the third user interaction satisfies the further set of content interaction rules, providing, to the third application, instructions regarding displaying of the third user interaction.

In some embodiments, the respective instructions include approval to display the first or second user interactions.

In some embodiments, the first and second applications are executing on a common application platform. In some embodiments, the set of content interaction rules includes rules that are unique for each application within the common application platform.

In some embodiments, the process 1100 may further involve generating a representation of a graphical user interface including the first user interaction according to the respective instructions. The graphical user interface may include a panel displaying content related to the first user interaction, a widget displaying the first user interaction, or a button allowing performance of an action related to the first user interaction. In some embodiments, the action related to the first user interaction involves submitting a further user interaction in reply to the first user interaction.

In some embodiments, obtaining the first content interaction indicator involves sending, via an application programming interface, one or more requests comprising an identifier relating to content associated with the first user interaction. In some embodiments, obtaining the first content interaction indicator involves receiving, via the application programming interface, one or more responses comprising information relating to the first user interaction. In some embodiments, the information relating to the first user interaction includes an identifier relating to the first user interaction, a creation timestamp of the first user interaction, or text relating to the first user interaction.

In some embodiments, the first and second user interactions include one or more of comments in the form of text-based user interactions, reactions in the form of image-based user interactions, or views involving a number of times content has been provided by an application.

In some embodiments, records of the first and second user interactions are stored in a database. The database may include content base records comprising permission flags associated with the first and second user interactions. The database may include reaction records linked to reaction configuration records within the database. In some embodiments, the reaction configuration records comprise text for a reaction or an icon related to the reaction. The database may also include view records comprising a number of times one of the first and second user interactions has been viewed. The database may include comment records comprising text submitted by a user in reply to content of the first and second applications. In some embodiments, a portion of the comment records comprise a reference to further comment records within the database such that the portion of the comment records are linked together in a chain of comments.

In some embodiments, the respective instructions involve displaying information about a user that submitted at least one of the first and second user interactions. In some embodiments, the information about the user includes a name, location, or avatar of the user.

In some embodiments, the process 1100 may be performed in connection with a computing system. The computing system may include at least one processor, as well as memory and program instructions. The program instructions may be stored in the memory, and upon execution by the at least one processor, cause the computing system to perform operations in accordance with process 1100.

In some embodiments, the process 1100 may be performed in connection with a non-transitory machine-readable medium. The non-transitory machine-readable medium may have stored thereon program instructions that, upon execution by a computing system, cause the computing system to perform operations in accordance with process 1100.

### IX. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a first content interaction indicator that indicates a first user interaction with content of a first application, and obtaining a second content interaction indicator that indicates a second user interaction with content of a second application different from the first application;
obtaining a set of content interaction rules associated with the first and second applications; and
in response to determining, based on the first and second content interaction indicators, that each of the first and second user interactions satisfies the set of content interaction rules, generating display instructions for displaying the first and second user interactions.

2. The method of claim 1, further comprising:
providing, to the first and second applications, the display instructions for displaying the first and second user interactions.

3. The method of claim 1, further comprising:
obtaining a third content interaction indicator that indicates a third user interaction with content of a third application different from the first and second applications; and
in response to determining that the third user interaction satisfies the set of content interaction rules, providing, to the third application, display instructions for displaying of the third user interaction.

4. The method of claim 1, further comprising:
obtaining a third content interaction indicator that indicates a third user interaction with content of a third application different from the first and second applications;
obtaining a further set of content interaction rules specific to the third application; and
in response to determining that the third user interaction satisfies the further set of content interaction rules, providing, to the third application, display instructions for displaying of the third user interaction.

5. The method of claim 1, wherein the display instructions comprise approval to display the first or second user interactions.

6. The method of claim 1, wherein the first and second applications are executing on a common application platform.

7. The method of claim 6, wherein the set of content interaction rules includes rules that are unique for each application within the common application platform.

8. The method of claim 1, further comprising:
generating a representation of a graphical user interface including the first user interaction according to the display instructions, wherein the graphical user interface includes: a panel displaying content related to the first user interaction, a widget displaying the first user interaction, or a button allowing performance of an action related to the first user interaction.

9. The method of claim 8, wherein the action related to the first user interaction involves submitting a further user interaction in reply to the first user interaction.

10. The method of claim 1, wherein obtaining the first content interaction indicator comprises:
sending, via an application programming interface, one or more requests comprising an identifier relating to content associated with the first user interaction; and
receiving, via the application programming interface, one or more responses comprising information relating to the first user interaction.

11. The method of claim 10, wherein the information relating to the first user interaction includes an identifier relating to the first user interaction, a creation timestamp of the first user interaction, or text relating to the first user interaction.

12. The method of claim 1, wherein the first and second user interactions include one or more of comments in a form of text-based user interactions, reactions in a form of image-based user interactions, or views involving a number of times content has been provided by an application.

13. The method of claim 12, wherein records of the first and second user interactions are stored in a database, and wherein the database includes:
content base records comprising permission flags associated with the first and second user interactions;
reaction records linked to reaction configuration records within the database, and wherein the reaction records comprise text for a reaction or an icon related to the reaction;
view records comprising a number of times one of the first and second user interactions has been viewed; and
comment records comprising text submitted by a user in reply to content of the first and second applications.

14. The method of claim 13, wherein a portion of the comment records comprise a reference to further comment records within the database such that the portion of the comment records are linked together in a chain of comments.

15. The method of claim 1, the respective instructions involve displaying information about a user that submitted at least one of the first and second user interactions.

16. The method of claim 15, wherein the information about the user includes a name, location, or avatar of the user.

17. A computing system comprising:
one or more processors;
memory; and
program instructions, stored in the memory, that upon execution by the one or more processors cause the computing system to perform operations comprising:
obtaining a first content interaction indicator that indicates a first user interaction with content of a first application, and obtaining a second content interaction indicator that indicates a second user interaction with content of a second application different from the first application;
obtaining a set of content interaction rules associated with the first and second applications; and
in response to determining, based on the first and second content interaction indicators, that each of the first and second user interactions satisfies the set of content interaction rules, generating display instructions for displaying the first and second user interactions.

18. The computing system of claim 17, wherein the operations further comprise:
providing, to the first and second applications, the display instructions for displaying the first and second user interactions.

19. A non-transitory machine-readable medium storing program instructions that, when executed by one or more processors of a computing system, cause the computing system to perform operations comprising:
obtaining a first content interaction indicator that indicates a first user interaction with content of a first application, and obtaining a second content interaction indicator that indicates a second user interaction with content of a second application different from the first application;
obtaining a set of content interaction rules associated with the first and second applications; and
in response to determining, based on the first and second content interaction indicators, that each of the first and second user interactions satisfies the set of content interaction rules, generating display instructions for displaying the first and second user interactions.

20. The non-transitory machine-readable medium of claim 19, wherein the operations further comprise:
providing, to the first and second applications, the display instructions for displaying the first and second user interactions.
